(19) United States
(12) Patent Application Publication
(10) Pub. No.: US 2015/0119514 A1
(43) Pub. Date: Apr. 30, 2015

(54) AQUEOUS COATING COMPOSITION HAVING STABILIZED COLOR PIGMENTS

(71) Applicant: AXALTA COATING SYSTEMS IP CO., LLC, Wilmington, DE (US)

(72) Inventor: An-Gong Yeh, Broomall, PA (US)

(21) Appl. No.: 14/400,012

(22) PCT Filed: May 9, 2013
(86) PCT No.: PCT/US2013/040315

§ 371 Date: Nov. 10, 2014

Related U.S. Application Data
(60) Provisional application No. 61/645,881, filed on May 11, 2012.

(51) Int. Cl. C09D 17/00

(52) U.S. Cl. CPC C09D 17/007; C09D 17/002
USPC 524/431; 524/504

(57) ABSTRACT

A stabilized color pigment dispersion includes a phosphated polymer, a color pigment stabilized in the phosphated polymer, and an aqueous carrier. The color pigment comprises one or more oxide color pigments and is essentially free from metallic pigments. The stabilized color pigment dispersion comprises in a range of from about 20% to about 80% of water, percentage based on the total weight of the stabilized color pigment dispersion.

### CROSS-REFERENCE TO RELATED APPLICATION

This application is a U.S. National-Stage entry under 35 U.S.C. §371 based on International Application No. PCT/US2013/040315, filed May 9, 2013, which was published under PCT Article 21(2) and which claims priority to U.S. Provisional Application No. 61/645,881, filed May 11, 2012, which are all hereby incorporated in their entirety by reference.

### TECHNICAL FIELD

The present disclosure is directed to a stabilized color pigment dispersion. This disclosure is further directed to a coating composition comprising the stabilized color pigment dispersion and metallic pigments, such as aluminum flakes.

### BACKGROUND

Metallic pigments such as aluminum flake pigments in coating compositions can be used in finishes, such as exterior finishes for automobiles and trucks, to provide the finishes with metallic glamour. There are relatively few problems with the addition of these metallic flakes by conventional methods to solvent based coating compositions. In waterborne compositions, however, the metallic flakes, in particular, aluminum flakes, can react with water and other constituents present in the coating composition causing flake deterioration and can cause the evolution of gas. In addition, finishes formed with such coatings have a reduced brightness and/or color saturation.

Accordingly, it is desirable to provide coatings having stable metallic pigments for long term stability and prevention of gassing. Furthermore, other desirable features and characteristics of the present invention will become apparent from the subsequent detailed description and the appended claims, taken in conjunction with the accompanying background.

### SUMMARY

In accordance with an exemplary embodiment, a stabilized color pigment dispersion comprises:

a phosphated polymer;

a color pigment stabilized in the phosphated polymer, the color pigment comprising an oxide color pigment and essentially free from metallic pigments; and

an aqueous carrier;

wherein the stabilized color pigment dispersion comprises in a range of from about 20% to about 80% of water, percentage based on the total weight of the stabilized color pigment dispersion.

In accordance with another exemplary embodiment, an aqueous coating composition comprises:

the stabilized color pigment dispersion disclosed herein;

a metallic pigment; and

a coating binder component; wherein

the stabilized color pigment dispersion and the metallic pigment are mixed in the coating binder component; and

the aqueous coating composition comprises in a range of from about 20% to about 80% of water, percentage based on the total weight of the aqueous coating composition.

In a further exemplary embodiment, a process for forming a coating composition comprises the steps of:

forming a stabilized color pigment dispersion by stabilizing a color pigment with a phosphated polymer in an aqueous carrier, the color pigment comprising an oxide color pigment and essentially free from metallic pigments, wherein the stabilized color pigment dispersion comprises in a range of from about 20% to about 80% of water, percentage based on the total weight of the stabilized color pigment dispersion; and

mixing the stabilized color pigment dispersion with a coating binder component and an aluminum pigment to form the coating composition.

Another exemplary embodiment is directed to a coating process for coating a substrate with a coating composition, the coating process comprising the steps of:

providing the coating composition disclosed herein; and

applying the coating composition over the substrate to form a wet metallic color coat layer thereon.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “dye” means a colorant or colorants that produce color or colors and is usually soluble in a coating composition.

The term “color pigment” or “color pigments” used herein refers to a colorant or colorants that produce color or colors and is usually not soluble in a coating composition. A color pigment can be from natural and synthetic sources and made of organic or inorganic constituents.

The term “effect pigment” or “effect pigments” refers to pigments that produce special effects in a coating. Examples of effect pigments can include, but not limited to, light absorbing pigment, light scattering pigments, light interference pigments, and light reflecting pigments. Metallic flakes, for example aluminum flakes, can be examples of such effect pigments. The term “gonioapparent flakes”, “gonioapparent pigment” or “gonioapparent pigments” refers to pigment or pigments pertaining to change in color, appearance, or a combination thereof with change in illumination angle or viewing angle. Metallic flakes, such as aluminum flakes are examples of gonioapparent pigments. Interference pigments or pearlescent pigments can be further examples of gonioapparent pigments.

The term “metallic pigment”, “metallic pigments”, “metal pigments” or “metal pigments” refers to particles or flakes of nonoxidized metal or alloys used as effect pigments to produce special effects in coatings. Examples of metallic pigments can include metallic flakes or particles, such as aluminum flakes or particles.

The term “oxide color pigments” or “metal oxide color pigments” refers to natural or synthetic oxide pigments that are compounds containing oxygen. For example, metal oxide color pigments can include iron oxides or hydrated iron oxides that are chemical compounds composed of iron and oxygen and can have different colors, such as yellow oxide (Fe₂O₃.H₂O), brown oxide (Fe₂O₃.xFeO), black oxide (Fe₃O₄), or red (Fe₂O₃) depending on the compositions. Other oxides, such as silicon oxides, manganese oxides, aluminum oxides, calcium oxides or magnesium oxides can also be included. The “oxide color pigments” or “metal oxide color pigments” can be present naturally or manufactured by a synthetic process.

This disclosure is directed to a stabilized color pigment dispersion. The stabilized color pigment dispersion comprises:

a phosphated polymer;

a color pigment stabilized in the phosphated polymer, the color pigment comprising an oxide color pigment and essentially free from metallic pigments; and

an aqueous carrier;

wherein the stabilized color pigment dispersion comprises in a range of from about 20% to about 80% of water, percentage based on the total weight of the stabilized color pigment dispersion.

The phosphated polymer can be a phosphated graft copolymer, a phosphated block copolymer, a phosphated linear polymer, a phosphated branched polymer, or a combination thereof

The phosphated polymer can be a phosphate linear polymer polymerized from unsaturated monomers in one example, a phosphate graft copolymer in another example, a phosphate block copolymer in yet another example, a phosphate branched copolymer in yet another example, or a combination thereof. The phosphated polymer can further comprise one or more functional groups selected from hydroxyl groups, epoxy groups, carboxyl groups, or a combination thereof. In a further example, phosphate styrene/allyl alcohol copolymer disclosed in U.S. Pat. No. 4,675,358 can be suitable. In a yet further example, phosphate graft copolymer disclosed in U.S. Pat. No. 5,502,113 can be suitable.

The color pigment is stabilized in the phosphated polymer, typically, by mixing. The color pigment can comprise one or more oxide color pigments and is essentially free from metallic pigments. By “essentially free”, the color pigment can comprise minor amounts of metallic pigments, typically less than about 1% of the metallic pigments, percentage based on the total weight of the color pigment. The color pigment can be of different colors and can be produced naturally or manufactured by a synthetic process. The color pigment can comprise one or more iron oxide color pigments. Other metal oxides, non-oxide or organic color pigments, such as silicon oxide, titanium oxides, organic azo pigments, copper phthalocyanine, carbon black, clay, or a combination thereof, can also be included. The color pigment can comprise in a range of from about 5% to 100% in one example, about 10% to 100% in another example, about 20% to 100% in yet another example, about 50% to 100% in yet another example, about 70% to 100% in yet another example, about 90% to 100% in yet another example of one or more iron oxide color pigments. The one or more iron oxide color pigments can be of different colors and can be produced naturally or manufactured by a synthetic process. The processes and compositions disclosed herein are particularly suitable for color pigments comprising one or more iron oxides.

The color pigment can also be dispersed first in the presence of water by a process known to those skilled in the art to form a color dispersion. The color dispersion can comprise in a range of from about 20% to about 80% of water, percentage based on the total weight of the color dispersion. The color dispersion then can be mixed with the phosphated polymer to form the stabilized color pigment dispersion.

The stabilized color pigment dispersion can further comprise one or more organic solvents. Typical organic solvents suitable for coating applications are suitable. Water soluble or water miscible organic solvents are preferred.

This disclosure is further directed to an aqueous coating composition. The aqueous coating composition comprises:

the stabilized color pigment dispersion disclosed herein;

one or more metallic pigments; and

a coating binder component; wherein

the stabilized color pigment dispersion and the metallic pigment are mixed in the coating binder component; and

the aqueous coating composition comprises in a range of from about 20% to about 80% of water, percentage based on the total weight of the aqueous coating composition.

The metallic pigment can comprise aluminum pigments, such as one or more aluminum flakes or particles. The aluminum flakes or particles can have different shapes, types, sizes, or a combination thereof. Typically, aluminum flakes or particles can be in shapes, types or sizes suitable for coating applications as effect pigments.

The stabilized color pigment dispersion, the metallic pigment, and the coating binder component can be mixed to form the coating composition. In one example, the stabilized color pigment dispersion and the coating binder component can be mixed first, and then the metallic pigment can be added to form the coating composition. In another example, the stabilized color pigment dispersion and the metallic pigment can be mixed first, and then the coating binder component can be added to form the coating composition. In yet another example, the stabilized color pigment dispersion, the metallic pigment, and the coating binder component can be mix at same time form the coating composition.

The color dispersion can be mixed with the phosphated polymer to form the stabilized color pigment dispersion, and further mixed with the coating binder component to form the aqueous coating composition.

The coating binder component can comprise one or more acrylic polymers, polyester polymers, latex polymers, polyurethane polymers, or a combination thereof. Typical polymers that are suitable for coating applications can be suitable. The coating binder component can comprise one or more functional groups selected from hydroxyl groups, epoxy groups, carboxyl groups, or a combination thereof, typically, on one or more of the aforementioned polymers present in the coating binder component.

The aqueous coating composition can further comprise one or more organic solvents. Typical organic solvents suitable for coating applications can be suitable. Water soluble or water miscible organic solvents are preferred.

The aqueous coating composition can further comprise one or more conventional pigments, coating additives, or a combination thereof. Examples of such additives include wetting agents, leveling and flow control agents, for example, Resiflow®S (polybutylacrylate), BYK® 320 and 325 (high molecular weight polyacrylates), BYK® 347 (polyether-modified siloxane) under respective registered trademarks, leveling agents based on (meth)acrylic homopolymers; rheological control agents; thickeners, such as partially crosslinked polycarboxylic acid or polyurethanes; and antifoaming agents. The additives can be used in conventional amounts familiar to those skilled in the art.

This disclosure is further directed to a coated article comprising a substrate and a metallic color coating layer formed over the substrate from the coating composition disclosed herein. The substrate can be a vehicle, vehicle parts, or a combination thereof. The substrate can also be other industrial or consumer articles, such as appliances, power tools, furniture, rails, tanks, etc.

The metallic color coating layer can be coated over a primer coating layer coated over the substrate. In one example, a substrate can be first coated with one or more primer layers and then subsequently coated over the primer layer with the aqueous coating composition disclosed herein.

This disclosure is even further directed to a process for forming a coating composition. In an exemplary embodiment, the process comprises the steps of:

forming a stabilized color pigment dispersion by stabilizing a color pigment with a phosphated polymer in an aqueous carrier, the color pigment comprising an oxide color pigment and essentially free from metallic pigments, wherein the stabilized color pigment dispersion comprises in a range of from about 20% to about 80% of water, percentage based on the total weight of the stabilized color pigment dispersion; and

mixing the stabilized color pigment dispersion with a coating binder component and an aluminum pigment to form the coating composition.

In the aforementioned process, the phosphated polymer can be a phosphated graft copolymer, a phosphated block copolymer, a phosphated linear polymer, a phosphated branched polymer, or a combination thereof, as described previously. The phosphated polymer can further comprise one or more functional groups selected from hydroxyl groups, epoxy groups, carboxyl groups, or a combination thereof

As mentioned above, the color pigment can also be dispersed into aforementioned color dispersion. The color dispersion then can be mixed with the phosphated polymer to form the stabilized color pigment dispersion, and further mixed with the coating binder component to form the aqueous coating composition.

The process can further comprise the step of mixing one or more organic solvents into the coating composition. The aforementioned organic solvents can be suitable.

The color pigment can comprise one or more iron oxide color pigments as described previously.

This disclosure is further directed to a coating process for coating a substrate with a coating composition. In an embodiment, the coating process comprises the steps of:

providing the coating composition disclosed herein; and

applying the coating composition over the substrate to form a wet metallic color coat layer thereon.

In one example, any of the aforementioned coating compositions can be suitable. In another example, any of the aforementioned coating compositions formed by the aforementioned processes can be suitable.

In an embodiment, the coating process further comprises the steps of:

curing the wet metallic color coat layer to form a dry metallic color coat layer over the substrate.

The coating layer can be cured at an ambient temperature in a range of from about 15° C. to about 45° C., an elevated temperature in a range of from about 45° C. to about 250° C., or a combination thereof. In one example, a coating, such as a refinish coating, can be cured at aforementioned ambient temperature. In another example a coating, such as an OEM (Original Equipment Manufacturing) coating, can be cured at aforementioned elevated temperature. In yet another example, a coating can be cured for a certain period of time, such as a few minutes to a few hours, at the ambient temperature, followed by curing at elevated temperature.

In an embodiment, the coating process further comprises the steps of:

applying a clear coating composition over the wet metallic color coat layer to form a wet clear coat layer thereon; and

curing the wet metallic color coat layer and the wet clear coat layer at same time.

After each wet coat layer is formed, an optional flashed step can be performed to remove some or all of the solvents. In one example, flashing can be performed after one wet metallic color coat layer is formed. In another example, subsequent coating layers can be directly applied over a previous wet coating layer without the flashing step. The coating layers can be cured together at an ambient temperature in a range of from about 15° C. to about 45° C., an elevated temperature in a range of from about 45° C. to about 250° C., or a combination thereof

In an embodiment, each coating layer is applied to have a thickness in a range of from about 0.1 mil to about 2 mils (about 2.5 to about 50 microns).

The clear coat layer can provide further protection to the substrate or provide further enhanced appearance, such as enhanced gloss. Typical clearcoat can be suitable. In one example, suitable clearcoat can include ChromaClear® available under trademark or registered trademark from E.I du Pont de Nemours and Company, Wilmington, USA.

The substrate can be a vehicle, vehicle parts, or a combination thereof

Phosphated polymers have been used to provide passivation of metallic pigments, such as aluminum flakes, such as those disclosed in U.S. Pat. No. 4,675,358 issued Jun. 23, 1987 and in U.S. Pat. No. 5,502,113 issued Mar. 26, 1996. The color pigments, however, are not passivated.

Applicant unexpectedly discovered that by passivating the color pigments that are essentially free from the metallic pigments before mixing the passivated color pigments with the metallic pigment into a coating composition, better color stability and less gassing can be achieved especially for aqueous coating compositions, such as the coating compositions that comprise in a range of from about 20% to about 80% of water.

### Examples

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example A

Stabilized color pigment dispersion A was formed by mixing a color pigment dispersion A with a phosphated polymer solution A according to Table 1.
The Color Pigment Dispersion A used for this example is available from E. I. du Pont de Nemours and Company, Wilmington, Del., USA and comprises 38.77% of water and 27.50% of Red Iron Oxide pigment SICOTRANS® RED L 2818 under registered trademark from BASF Aktiengesellschaft, Ludwigshafen, Germany. The Color Pigment Dispersion A was essentially free from metallic pigments.

TABLE 1
Stabilized color pigment dispersion A (weight percent).

| | | Wt % |
|---|---|---|
| Color Pigment Dispersion A | | 30.73 |
| Phosphated Polymer A: | | 64.00 |
| Water | 33.77%, | |
| 10% DMEA (dimethyl ethanol amine) | 15.00% | |
| polyurethane emulsion dispersion ⁽¹⁾ | 7.03%, | |
| phosphate polymer A ⁽²⁾ | 8.0% | |
| bactericides and fungicides ⁽³⁾ | 0.2% | |
| Subtotal | 64.00% | |
| Acrylic polymer ⁽⁴⁾ | | 2.10 |
| 10% DMEA | | 3.17 |
| Total | | 100. |

⁽¹⁾ The polyurethane emulsion dispersion used was available from E. I. du Pont de Nemours and Company, Wilmington, DE, USA.
⁽²⁾ The phosphate polymer A used was the phosphated graft acrylic polymer described in U.S. Pat. No. 5,502,113.
⁽³⁾ The bactericides and fungicides used was MERGAL ® K10N, available under respective registered trademark from Troy Corporation, Florham Park, New Jersey, USA.
⁽⁴⁾ The acrylic polymer used was Rheotech 3000 acrylic polymer available from COATEX Inc., CHESTER, SC, USA.

The phosphated polymer solution A was pre-blended before mixing with the color pigment dispersion. The acrylic polymer, Rheotech 3000 and amine reducer, dimethyl ethanol amine, can be optional and were introduced to enhance pigment tone shelf life stability. The polyurethane emulsion was introduced as a part of binders for color base coat and can be selected based on the binders of the coating.

Color Coating Composition A was a color coating having metallic beige color and was prepared according to Table 2.

TABLE 2
Color Coating Composition A.

| Ingredients | Wt % |
|---|---|
| Binder I ⁽⁵⁾ | 10.55 |
| Viscosity Balancer ⁽⁶⁾ | 24.61 |
| Aluminum Flakes ⁽⁷⁾ | 53.10 |
| Flatting Agent ⁽⁸⁾ | 5.75 |
| Red Transoxide ⁽⁹⁾ | 4.86 |
| White LS ⁽¹⁰⁾ | 0.79 |
| Red Oxide ⁽¹¹⁾ | 0.35 |
| Total | 100.00 |

The Color Coating Composition A was adjusted to have 50% to 80% of water, percentage based on the total weight of the Color Coating Composition A. Following Cromax Pro ® components available from E. I. du Pont de Nemours and Company, Wilmington, DE, USA, under respective trademarks and registered trademarks, were used for preparing the Color Compositing Composition A:
⁽⁵⁾ WB2010 ™;
⁽⁶⁾ WB2030 ™;
⁽⁷⁾ WB1032 ™;
⁽⁸⁾ WB1050 ™;
⁽⁹⁾ The Stabilized color pigment dispersion A prepared above;
⁽¹⁰⁾ WB02 ™; and
⁽¹¹⁾ WB84 ™.

### Example B

Stabilized color pigment dispersion B was formed by mixing a color pigment dispersion B with a phosphated polymer solution B according to Table 3.
The Color Pigment Dispersion B used for this example is available from E. I. du Pont de Nemours and Company, Wilmington, Del., USA and comprises 47.05% of water and 14.25% of Red Iron Oxide pigment SICOTRANS® RED L 2818 under registered trademark from BASF Aktiengesellschaft, Ludwigshafen, Germany. The Color Pigment Dispersion B was essentially free from metallic pigments.

TABLE 3
Stabilized color pigment dispersion B (weight percent).

| | | Wt % |
|---|---|---|
| Color Pigment Dispersion B | | 50.2 |
| Phosphated Polymer B: | | 47.7 |
| Water | 21.62% | |
| 10% DMEA (dimethyl ethanol amine) | 9.10% | |
| polyurethane emulsion dispersion ⁽¹⁾ | 12.78% | |
| phosphate polymer B ⁽¹²⁾ | 4.00% | |
| bactericides and fungicides ⁽³⁾ | 0.2% | |
| Subtotal | 47.7% | |
| Acrylic polymer ⁽⁴⁾ | | 2.10 |
| Total | | 100.0 |

^{(1), (3)} and ⁽⁴⁾ Same as that in Table 1.
⁽¹²⁾ The phosphate polymer B used was the phosphated polymer described in U.S. Pat. No. 4,675,358.

The phosphated polymer solution B was pre-blended before mixing with the color pigment dispersion. The acrylic polymer, Rheotech 3000 and amine reducer, dimethyl ethanol amine, can be optional and were introduced to enhance pigment tone shelf life stability. The polyurethane emulsion was introduced as a part of binders for color base coat and can be selected based on the binders of the coating.
Color Coating Composition B was a color coating having metallic beige color and was prepared according to Table 4.

TABLE 4
Color Coating Composition B.

| Ingredients | Wt % |
|---|---|
| Binder I ⁽⁵⁾ | 10.55 |
| Viscosity Balancer ⁽⁶⁾ | 24.61 |
| Aluminum Flakes ⁽⁷⁾ | 53.10 |
| Flatting Agent ⁽⁸⁾ | 5.75 |
| Red Transoxide ⁽¹³⁾ | 4.86 |
| White LS ⁽¹⁰⁾ | 0.79 |
| Red Oxide ⁽¹¹⁾ | 0.35 |
| Total | 100.00 |

The Color Coating Composition B was adjusted to have 50% to 80% of water, percentage based on the total weight of the Color Coating Composition B.
⁽⁵⁾⁻⁽⁸⁾ and ⁽¹⁰⁾⁻⁽¹¹⁾ same as that in Table 2.
⁽¹³⁾ The Stabilized color pigmentation dispersion B prepared above.

The Color Coating Composition B was adjusted to have 50% to 80% of water, percentage based on the total weight of the Color Coating Composition B.

### Comparative Example C

Comparative Dispersion C prepared by mixing the Color Pigment Dispersion B with water, polyurethane emulsion, biocide, and thickener according to Table 5 without phosphated polymers.

TABLE 5
Comparative Dispersion C (weight percent).

| | Wt % |
|---|---|
| Color Pigment Dispersion B | 50.20 |
| Water | 25.62 |
| 10% DMEA (dimethyl ethanol amine) | 9.10 |
| polyurethane emulsion dispersion ⁽¹⁾ | 12.78 |
| bactericides and fungicides ⁽³⁾ | 0.20 |
| Acrylic polymer ⁽⁴⁾ | 2.10 |
| Total | 100.00 |

^{(1), (3)} and ⁽⁴⁾ Same as that in Table 1.

Comparative Coating Composition C was a color coating having metallic beige color and was prepared according to Table 6.

TABLE 6
Comparative Coating Composition C.

| Ingredients | Wt % |
|---|---|
| Binder I ⁽⁵⁾ | 10.55 |
| Viscosity Balancer ⁽⁶⁾ | 24.61 |
| Aluminum Flakes ⁽⁷⁾ | 53.10 |
| Flatting Agent ⁽⁸⁾ | 5.75 |
| Red Transoxide ⁽¹⁴⁾ | 4.86 |
| White LS ⁽¹¹⁾ | 0.79 |
| Red Oxide ⁽¹¹⁾ | 0.35 |
| Total | 100.00 |

The Comparative Coating Composition C was adjusted to have 50% to 80% of water, percentage based on the total wieght of the Comparative Coating Composition C.
⁽⁵⁾⁻⁽⁸⁾ and ⁽¹⁰⁾⁻⁽¹¹⁾ same as that in Table 2.
⁽¹⁴⁾ The Comparative Pigment Dispersion C prepared above;

The Comparative Coating Composition C was adjusted to have 50% to 80% of water, percentage based on the total weight of the Comparative Coating Composition C.

### Color Saturation and Color Stability

Color coating compositions A, B and C were each sprayed on individual 4″×12″ E-coat panels via Sata spray gun (3000 RP HVLP) at an air pressure of 30 psig to form one or more layers of respective basecoat on each of the panels. Thickness of the basecoat was in a range of from 0.4 to 0.6 mils (about 10 to 15 microns). No flash was performed between the coatings. A clear coat was applied over each of the basecoat using ChromaClear® 72100S available under trademark or registered trademark from E.I du Pont de Nemours and Company, Wilmington, USA. The clearcoat was applied over the basecoat after the last coating of the basecoat was completely flat. Coatings were applied and dried at room temperatures in a range of from 20° C. to 25° C. The panels were dried and then evaluated for their initial color positions. Similar spray panels were prepared after the coating compositions were stored on shelf for a certain period of time as indicated in Table 7. The colors were measured using a commercially available X-rite instrument from X-Rite Incorporated, Grand Rapids, Mich., USA.

TABLE 7
Color Saturation and Stability.

| Panels with Coating | Initial | | 24 hr | | 1 week | |
|---|---|---|---|---|---|---|
| Compositions | a | b | a | b | a | b |
| Ex 1 (Panel with Color | 2.7 | 11.4 | 3.0 | 11.0 | 2.9 | 10.7 |
| Coating Composition A) | | | | | | |
| Ex 2 (Panel with Color | 3.1 | 10.6 | 3.1 | 10.2 | 3.2 | 10.2 |
| Coating Composition B) | | | | | | |
| Comp 1 (Panel with | 2.9 | 8.5 | 3.0 | 7.9 | 3.0 | 8.0 |
| Comparative Coating | | | | | | |
| Composition C) | | | | | | |

The comparative coating composition C showed an initial b value, or yellowness, of 8.5, which was 2 to 3 units less saturated than the coating compositions A and B. This color loss was visible and undesirable. The comparative coating composition C also showed color loss after 24 hours with the b value from 8.5 initial to 7.9 at 24 hours. Color coating compositions A and B showed more saturated colors without color loss after storing the color coating compositions for one week.

### Gassing Stability

The stabilized color pigment dispersion A, B and the Comparative Dispersion C prepared above were mixed with aluminum pigments according to Table 8 to determine their gassing stability.

TABLE 8
Mixtures of dispersions and aluminum pigments (wt %).

| | Ex | Ex | Ex | Ex | Comp | Comp |
|---|---|---|---|---|---|---|
| | 3 | 4 | 5 | 6 | 2 | 3 |
| Stabilized color | 30 | 30 | | | | |
| pigment dispersion A ⁽¹⁵⁾ | | | | | | |
| Stabilized color | | | 30 | 30 | | |
| pigment dispersion B ⁽¹⁶⁾ | | | | | | |
| Comparative | | | | | 30 | 30 |
| Dispersion C ⁽¹⁷⁾ | | | | | | |
| Aluminum | 10 | | 10 | | 10 | |
| pigments 1 ⁽¹⁸⁾ | | | | | | |
| Aluminum | | 10 | | 10 | | 10 |
| pigments 2 ⁽¹⁹⁾ | | | | | | |
| Binder I ⁽⁵⁾ | 60 | 60 | 60 | 60 | 60 | 60 |
| Total | 100 | 100 | 100 | 100 | 100 | 100 |

⁽⁵⁾Same as that in Table 2.
⁽¹⁵⁾From Example A (Table 1).
⁽¹⁶⁾From Example B (Table 3).
⁽¹⁷⁾From Comparative Example C (Table 5).
⁽¹⁸⁾⁻⁽¹⁹⁾The Aluminum pigments 1 used was WB1032 ™ and Aluminum pigments 2 used was WB1078 ™, all available as Cromax Pro ® components from E. I. du Pont de Nemours and Company, Wilmington, DE, USA, under respective trademarks and registered trademarks.

Specimens of 15 grams from each of the above mixtures in triplicates were filled into a 20 ml vial and then sealed with a rubber cap. The sealed vials were placed in 40° C. oven for 24 hours. A needle pressure gauge was then penetrated into each of the sealed vials for pressure build-up measurements after the vials were taken out of the oven and cooled to room temperature at about 25° C. Gas pressure data measured as psig (pound-force per square inch gauge) in triplicates are shown in Table 9. The comparative dispersion C showed a significant pressure build-up when mixed with aluminum pigments due to hydrogen gas generation via reactions of aluminum flakes and iron oxide pigments. The stabilized color pigment dispersions A and B had no gas generation problems.

TABLE 9
Gassing Data (psig).

| | Specimen 1 | Specimen 2 | Specimen 3 |
|---|---|---|---|
| Ex 3 | −1.32 | −0.16 | 0.46 |
| Ex 4 | −0.14 | 0.34 | −1.42 |
| Ex 5 | 0.06 | −0.92 | −1.1 |
| Ex 6 | −1.16 | −0.66 | −0.64 |
| Comp 2 | 8.08 | 6.2 | 13.22 |
| Comp 3 | −0.82 | 11.9 | 3.68 |

1. A stabilized color pigment dispersion comprising:
a phosphated polymer;
a color pigment stabilized in the phosphated polymer, the color pigment comprising one or more oxide color pigments and essentially free from metallic pigments; and
an aqueous carrier;
wherein the stabilized color pigment dispersion comprises in a range of from about 20% to about 80% of water, percentage based on the total weight of the stabilized color pigment dispersion.

2. The stabilized color pigment dispersion of claim 1, wherein the phosphated polymer is a phosphated graft copolymer, a phosphated block copolymer, a phosphated linear polymer, a phosphated branched polymer, or a combination thereof.

3. The stabilized color pigment dispersion of claim 1, wherein the color pigment comprises one or more iron oxide color pigments.

4. The stabilized color pigment dispersion of claim 1 further comprising one or more organic solvents.

5. The stabilized color pigment dispersion of claim 1, wherein the phosphated polymer further comprises one or more functional groups selected from hydroxyl groups, epoxy groups, carboxyl groups, and a combination thereof.

6. An aqueous coating composition comprising:
a stabilized color pigment dispersion comprising:
a phosphated polymer;
a color pigment stabilized in the phosphated polymer, the color pigment comprising one or more oxide color pigments and essentially free from metallic pigments; and
an aqueous carrier;
wherein the stabilized color pigment dispersion comprises in a range of from about 20% to about 80% of water, percentage based on the total weight of the stabilized color pigment dispersion.
a metallic pigments; and
a coating binder component;
wherein the stabilized color pigment dispersion and the metallic pigment are mixed in the coating binder component; and
the aqueous coating composition comprises in a range of from about 20% to about 80% of water, percentage based on the total weight of the aqueous coating composition.

7. The aqueous coating composition of claim 6, wherein the metallic pigment comprises an aluminum pigment.

8. The aqueous coating composition of claim 6, wherein the coating binder component comprises one or more acrylic polymers, polyester polymers, latex polymers, polyurethane polymers, or a combination thereof.

9. The aqueous coating composition of claim 6, wherein the coating binder component comprises one or more functional groups selected from hydroxyl groups, epoxy groups, carboxyl groups, and a combination thereof.

10. The aqueous coating composition of claim 6 further comprising one or more organic solvents.

11. (canceled)

12. (canceled)

13. (canceled)

14. A process for forming a coating composition, the process comprising the steps of:
forming a stabilized color pigment dispersion by stabilizing a color pigment with a phosphated polymer in an aqueous carrier, wherein the color pigment comprises one or more oxide color pigments and is essentially free from metallic pigments, wherein the stabilized color pigment dispersion comprises in a range of from about 20% to about 80% of water, percentage based on the total weight of the stabilized color pigment dispersion; and
mixing the stabilized color pigment dispersion with a coating binder component and an aluminum pigment to form the coating composition.

15. The process of claim 14, wherein the phosphated polymer is a phosphated graft copolymer, a phosphated block copolymer, a phosphated linear polymer, a phosphated branched polymer, or a combination thereof.

16. The process of claim 14 further comprising the step of mixing one or more organic solvents into the coating composition.

17. The process of claim 14, wherein the color pigment comprises one or more iron oxide color pigments.

18. The process of claim 14, wherein the phosphated polymer further comprises one or more functional groups selected from hydroxyl groups, epoxy groups, carboxyl groups, and a combination thereof.

19. (canceled)

20. (canceled)

21. (canceled)

22. (canceled)
